(19) United States
(12) Patent Application Publication
(10) Pub. No.: US 2024/0378350 A1
(43) Pub. Date: Nov. 14, 2024

(54) SYSTEM AND METHOD FOR VEHICLE DESIGN

(71) Applicant: Toyota Research Institute, Inc., Los Altos, CA (US)

(72) Inventors: Chenyang Yuan, Cambridge, MA (US); Nikos Arechiga Gonzalez, San Mateo, CA (US); Frank Permenter, Cambridge, MA (US)

(73) Assignees: Toyota Research Institute, Inc., Los Altos, CA (US); Toyota Jidosha Kabushiki Kaisha, Toyota-Shi (JP)

(21) Appl. No.: 18/451,214

(22) Filed: Aug. 17, 2023

Related U.S. Application Data
(60) Provisional application No. 63/465,613, filed on May 11, 2023.
(60) Provisional application No. 63/471,389, filed on Jun. 6, 2023.

(51) Int. Cl. G06F 30/27; G06F 30/15

(52) U.S. Cl. CPC G06F 30/27; G06F 30/15

(57) ABSTRACT

Systems, methods, and other embodiments described herein relate to generating vehicle design using a diffusion model. In one embodiment, a method includes generating a plurality of images based on a textual artistic guidance and a numerical constraint using a diffusion model.

### CROSS-REFERENCE TO RELATED APPLICATION

This application claims priority to U.S. Provisional Patent Application No. 63/465,613 filed May 11, 2023, and U.S. Provisional Patent Application No. 63/471,389 filed Jun. 6, 2023, the contents of both are hereby incorporated by reference in their entirety.

### TECHNICAL FIELD

The subject matter described herein relates, in general, to systems and methods for vehicle design.

### BACKGROUND

Machine learning models are useful in generating data. Machine learning models may generate data based on text. However, the context in which the machine learning models can use the text is limited. As such, the machine learning models are incapable of generating data that meet a constraint provided in text format.

### SUMMARY

In one embodiment, a system for generating vehicle design using a diffusion model is disclosed. The system includes a processor and a memory in communication with the processor. The memory stores machine-readable instructions that, when executed by the processor, cause the processor to generate a plurality of images based on a textual artistic guidance and a numerical constraint using a diffusion model.

In another embodiment, a method for generating vehicle design using a diffusion model is disclosed. The method includes generating a plurality of images based on a textual artistic guidance and a numerical constraint using a diffusion model.

In another embodiment, a non-transitory computer-readable medium for generating vehicle design using a diffusion model is disclosed. The non-transitory computer-readable medium includes instructions that, when executed by a processor, cause the processor to generate a plurality of images based on a textual artistic guidance and a numerical constraint using a diffusion model.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a data flow of a vehicle design system.

FIG. 2 illustrates an example of a data flow in a diffusion model.

FIG. 3 illustrates one embodiment of the vehicle design system.

FIG. 4 is a flowchart illustrating one embodiment of a method associated with vehicle design.

### DETAILED DESCRIPTION

Systems, methods, and other embodiments associated with systems and methods for vehicle design are disclosed. Utilizing Generative AI (Artificial Intelligence) tools for vehicle design may lead to significant inefficiency as the Generative AI tools are not capable of considering constraints when generating vehicle designs, and as such, may generate vehicle designs that do not meet, as an example, engineering constraints such as drag coefficient. This may lead to multiple vehicle design iterations that are repeatedly reviewed by designers and engineers before achieving a vehicle design that meets the desired constraints.

Current methods for generating vehicle design using Generative AI tools may not include breakthrough creativity as the Generative AI tools may generate designs based on a distribution of existing designs. Further and as previously mentioned, the Generative AI tools do not consider constraints when generating designs. Although, Generative AI tools may consider generalized text prompts that may further describe a reference image to be inputted to the Generative AI tools, the Generative AI tools are unable to consider specific machine-interpretable representations such as drag coefficients and/or vehicle weight distribution when generating a design.

Product designers, such as vehicle designers, can draw inspiration from various sources such as books or from the internet. However, while these sources may have images that provide artistic inspiration, the images may not satisfy numerical or quantifiable constraints including engineering constraints such as relating to aerodynamics.

Accordingly, systems, methods, and other embodiments associated with vehicle design which satisfy numerical constraints using a diffusion model are disclosed. Diffusion models are a class of probabilistic generative models that turn noise into a representative data sample. However, minimizing the output of a diffusion model based on a numerical constraint may result in a noisy image. As such and an example, the system includes a diffusion model that is trained to output a plurality of images based on textual artistic guidance and numerical constraints. The system may feed one or more textual artistic guidance, such as “sleek sporty sports car” to the diffusion model and may further feed one or more numerical constraints, such as a drag coefficient and a vehicle dimension. In response to receiving the textual artistic guidance and the numerical constraints, the diffusion model outputs a plurality of images that meet both the “sleek sporty sports car” guidance, the drag coefficient value, and the vehicle dimension.

The embodiments disclosed herein present various advantages over conventional technologies that generate vehicle design. The embodiments generate images that meet at least two requirements, artistic inspiration and numerical constraints. As such, the embodiments are able to produce and fine-tune novel artistic designs that satisfy engineering constraints.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

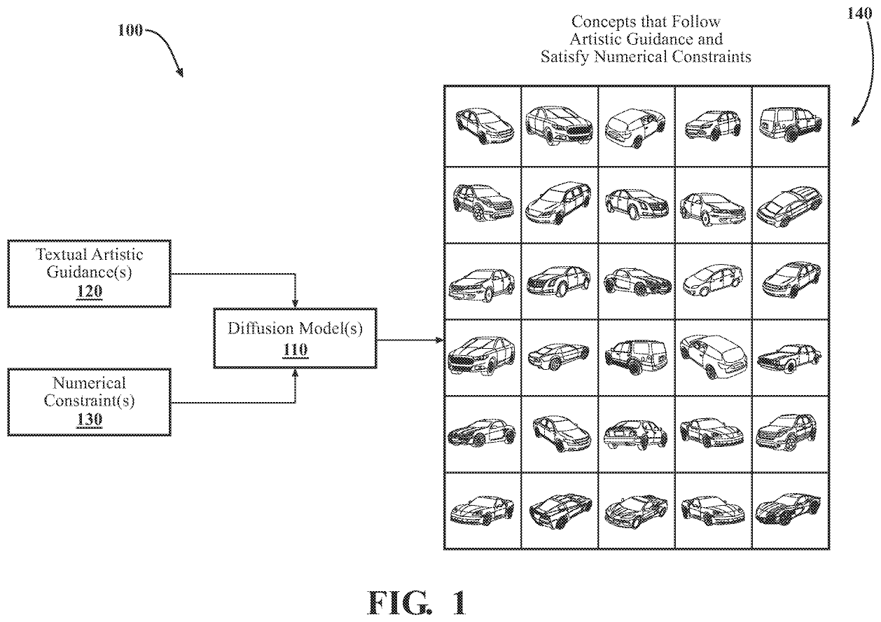

FIG. 1 illustrates a data flow of a vehicle design system 100. The vehicle design system 100 may include various elements, which may be communicatively linked in any suitable form. As an example, the elements may be connected, as shown in FIG. 1. Some of the possible elements of the vehicle design system 100 are shown in FIG. 1 and will now be described. It will be understood that it is not necessary for the vehicle design system 100 to have all the elements shown in FIG. 1 or described herein. The vehicle design system 100 may have any combination of the various elements shown in FIG. 1. Further, the vehicle design system 100 may have additional elements to those shown in FIG. 1. In some arrangements, the vehicle design system 100 may not include one or more of the elements shown in FIG. 1.

The vehicle design system 100 includes one or more diffusion models 110. The diffusion model(s) 110 may be any suitable machine learning models. The diffusion model 110 is a generative model. As such, the diffusion model 110 may also be referred to as a diffusion-based generative model. Generative models are a class of machine learning models that can generate new data based on training data. As an example, the diffusion model 110 is capable of generating images such as high-resolution images. The diffusion model 110 may generate a plurality of images 140 based on a textual artistic guidance 120 and a numerical constraint 130. The textual artistic guidance 120 is a description of an object in a text format. As an example, the textual artistic guidance 120 may include words like sleek, sporty, luxury, powerful, modern, tough, fast, smooth, comfort, responsive, family, agile, sports car, truck, 4×4, pickup, etc. The numerical constraint 130 is a quantifiable or measurable characteristic of the object described by the textual artistic guidance 120. As an example, in the case of the object being a vehicle, the numerical constraint 130 may be a drag coefficient, a manufacturability criterion, a vehicle dimension, a vehicle structural strength, and/or a vehicle weight distribution. The numerical constraint 135 may be in a text format.

In general, the diffusion model 110 receives the textual artistic guidance(s) 120 and the numerical constraint(s) 130. The diffusion model 110 then outputs a plurality of images 140 in any suitable format based on and guided by the textual artistic guidance(s) 120 and the numerical constraint(s) 130.

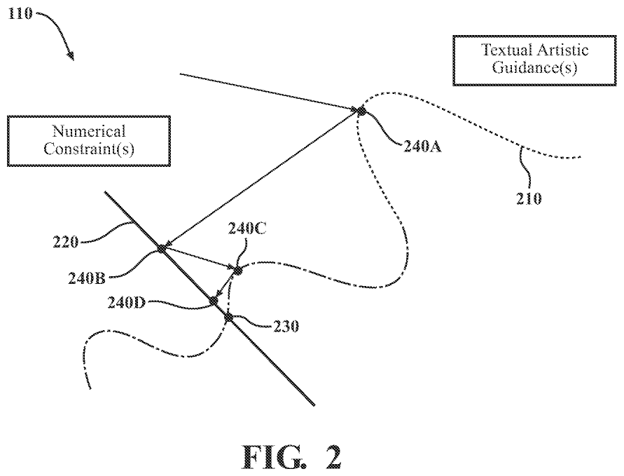

FIG. 2 illustrates an example of a data flow in a diffusion model 110. The diffusion model 110 is trained on textual artistic guidance(s) 120 and on numerical constraint(s) 130. As such, the diffusion model 110 is trained to meet multiple goals including a goal based on the textual artistic guidance 120 and a goal based on the numeral constraint 130. In general, the diffusion model 110 may be trained to meet multiple goals including multiple goals based on the textual artistic guidance(s) 120 and multiple goals based on the numerical constraint(s) 130.

As an example, the diffusion model may be trained using a denoising score matching method as follows:

Step I: Based on an image x, a noise level t, noise εₜ, generate noisy images x+εₜ.

Step II: Estimate the score function of the data density for the noisy images x+εₜ:

$$ℒ ( ∅ ) = {E}_{x , t} {‖ {ε}_{x , t} - {D}_{θ} ( x + {ε}_{t} , t ) ‖}^{2}$$

Step III: Train the diffusion model as a denoiser D (x,t) on the noisy images x+εₜ based on [symbol] (Ø).

This method assumes that the images lie on a low-dimensional manifold high-dimensional pixel space. As such, the noise εₜ is orthogonal to the image manifold with high probability and the diffusion model is learning a projector operator onto the image manifold.

As shown in FIG. 2 and as an example, a first line 210 is an image manifold and represents when the diffusion model 110 outputs images that meet the textual artistic guidance(s) 120. The second line 220 is a numerical constraint and represents when the diffusion model 110 outputs images that meet the numerical constraints 130. The point of intersection 230 between the first line 210 and the second line 220 represents when the diffusion model 110 outputs images 140 that meet both the textual artistic guidance(s) 120 and the numerical constraint(s) 130. In this example, the diffusion model 110 is trained to output images based on two goals-one goal based on the textual artistic guidance 120 and one goal based on the numerical constraint 130.

As an example and as shown, the diffusion model 110 cycles through multiple iterations before outputting the images 140. As illustrated, in a first iteration, the diffusion model 110 may generate images that meet the textual artistic guidance 120 along the first line 210 at a first point 240A. The diffusion model 110 may measure the variance between the characteristics of the images and the numerical constraint 130 using any suitable method. At the first point 240A, the diffusion model 110 determines that the images meet the textual artistic guidance 120, however, the images do not meet the numerical constraint 130. As such, in a second iteration, the diffusion model 110 generates images that meet the numerical constraint 130 along the second line 220 at a second point 240B. At the second point 240B, the diffusion model 110 determines that the images meet the numerical constraint 130, however, the images do not meet the textual artistic guidance 120. In a third iteration, the diffusion model 110 generates images that meet the textual artistic guidance 120 at a third point 240C and although the images do not meet the numerical constraints 130, the images at the third point 240C are closer to meeting the numerical constraints 130 than the images at the first point 240A. Over further iterations, the diffusion model 110 may continue to generate the images, measure the variance between the characteristics between the images and the goal(s), and then refine the images accordingly. As such, the diffusion model 110 may finally generate the images 140 that meet both the textual artistic guidance(s) 120 and the numerical constraint(s) 130.

As an example of the numerical constraint 130 being a drag coefficient, the diffusion model 110 receives a maximum drag coefficient value. In such an example, the diffusion model 110 may determine the drag coefficient of the images based on the size and shape of the images 140 using a suitable formula and/or method. The diffusion model 110 may then compare the drag coefficient of the images to the maximum drag coefficient value to determine the variance.

As an example of the numerical constraint being a manufacturability criterion, the diffusion model 110 may receive a manufacturability criterion. A manufacturability criterion refers to factors to be considered during the manufacturing process of the object described by the textual artistic guidance 120. As an example, a manufacturability criterion may be the time in which the object is to be produced, the amount of computer and/or power resources available to produce the object, and/or the amount of material required to produce the object. The diffusion model 110 may receive one or more manufacturability criteria. The manufacturability criteria may be based on a checklist of various factors that affect the manufacturing process of the object. As an example, the diffusion model 110 may determine and measure the manufacturability criterion of the object based on the size and shape of the images using a suitable formula and/or method. The diffusion model 110 may then compare the manufacturability criterion of the images to the received manufacturability criterion to determine the variance.

As an example of the numerical constraint being a vehicle dimension, the diffusion model 110 may receive a minimum or maximum vehicle dimension. The vehicle dimension may be related to the whole vehicle or a portion of the vehicle such as the wheel of the vehicle, the body of the vehicle, the window(s) of the vehicle, the front hood of the vehicle, and/or the trunk of the vehicle. The diffusion model 110 may receive one or more vehicle dimensions. As an example, the diffusion model 110 may determine and measure the vehicle dimension(s) of the images based on the size and shape of the images using a suitable formula and/or method. The diffusion model 110 may then compare the vehicle dimension(s) of the images to the received minimum or maximum vehicle dimension(s) to determine the variance.

As an example of the numerical constraint being a vehicle structural strength, the diffusion model 110 may receive any suitable vehicle structural strength values such as a strength-to-weight ratio. The diffusion model 110 may apply any suitable method or formula to determine the variance between the vehicle structural strength of the images and the received vehicle structural strength value(s).

As an example of the numerical constraint being a vehicle weight distribution, the diffusion model 110 may receive a vehicle weight distribution ratio, referring to the distribution of the weight of the vehicle on the wheels of the vehicle. As an example, the vehicle weight distribution ratio may be a ratio of 50-50, such that 50 percent of the weight of the vehicle is on the front wheels and 50 percent of the weight of the vehicle is on the rear wheels. The diffusion model 110 may apply any suitable method or formula to determine the variance between the vehicle weight distribution in the images 140 and the received vehicle weight distribution ratio.

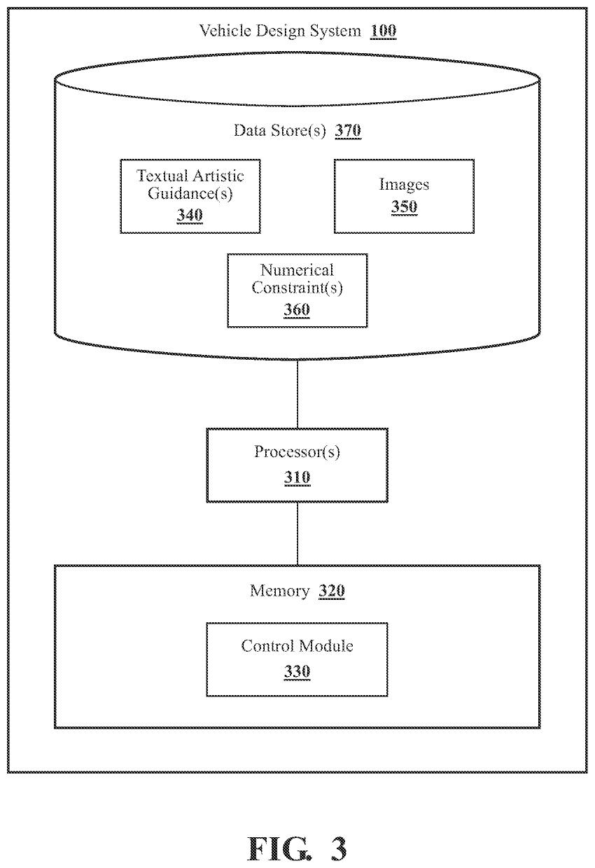

With reference to FIG. 3, one embodiment of the vehicle design system 100 of FIG. 1 is further illustrated. The vehicle design system 100 is shown as including a processor 310. Accordingly, the processor 310 may be a part of the vehicle design system 100, or the vehicle design system 100 may access the processor 310 through a data bus or another communication path. In one or more embodiments, the processor 310 is an application-specific integrated circuit (ASIC) that is configured to implement functions associated with a control module 330. In general, the processor 310 is an electronic processor, such as a microprocessor, that is capable of performing various functions as described herein.

In one embodiment, the vehicle design system 100 includes a memory 320 that stores the control module 330 and/or other modules that may function in support of generating vehicle design. The memory 320 is a random-access memory (RAM), read-only memory (ROM), a hard disk drive, a flash memory, or another suitable memory for storing the control module 330. The control module 330 is, for example, machine-readable instructions that, when executed by the processor 310, cause the processor 310 to perform the various functions disclosed herein. In further arrangements, the control module 330 is a logic, integrated circuit, or another device for performing the noted functions that includes the instructions integrated therein.

Furthermore, in one embodiment, the vehicle design system 100 includes a data store 370. The data store 370 is, in one arrangement, an electronic data structure stored in the memory 320 or another data store, and that is configured with routines that can be executed by the processor 310 for analyzing stored data, providing stored data, organizing stored data, and so on. Thus, in one embodiment, the data store 370 stores data used by the control module 330 in executing various functions.

For example, as depicted in FIG. 3, the data store 370 includes the textual artistic guidance(s) 340, the images 350, and the numerical constraint(s) 360, along with, for example, other information that is used and/or produced by the control module 330. The images 350 may include the images 140 generated by the diffusion model 110. The textual artistic guidance(s) 340 and/or the numerical constraints 360 may be generated and/or entered using any suitable means such as by a user. The textual artistic guidance(s) 340 may include the textual artistic guidance(s) 120 being received by the diffusion model 110. The numerical constraints(s) 360 may include the numerical constraint(s) 130 being received by the diffusion model 110.

While the vehicle design system 100 is illustrated as including the various data elements, it should be appreciated that one or more of the illustrated data elements may not be included within the data store 370 in various implementations and may be included in a data store that is external to the vehicle design system 100. In any case, the vehicle design system 100 stores various data elements in the data store 370 to support functions of the control module 330.

In one embodiment, the control module 330 includes instructions that, when executed by the processor(s) 310, cause the processor(s) 310 to generate a plurality of images 140 based on a textual artistic guidance(s) 120 and a numerical constraint 130 using a diffusion model 110. In one or more arrangements, the plurality of images 140 may be representations of a vehicle. Further, the textual artistic guidance 120 may be a description of a vehicle. In one or more arrangements and as previously mentioned, the numerical constraint 130 may be based on a drag coefficient, a manufacturability criterion, a vehicle dimension, a vehicle structural strength, or a vehicle weight distribution.

In one or more arrangements, the control module 330 can feed the textual artistic guidance(s) 120 and the numerical constraint(s) 130 to the diffusion model 110 and the diffusion model 110 can generate the images 140 based on the textual artistic guidance(s) 120 and the numerical constraint(s) 130. As an example and as previously described, the diffusion model 110 can run through one or more iterations to generate a set of images 140 that meet both the textual artistic guidance(s) 120 and the numerical constraint(s) 130.

In one embodiment, the control module 330 includes instructions that, when executed by the processor(s) 310, cause the processor(s) 310 to generate the plurality of images 140 based on at least a plurality of textual artistic guidance(s) 120. As such, the diffusion model 110 may be trained to output multiple images 140 based on multiple textual artistic guidances 120. As an example, the multiple textual artistic guidances 120 may include multiple text descriptions such as sleek, powerful, and smooth. The diffusion model 110 may receive the multiple text descriptions and then generate images 140 that meet the multiple text descriptions. As previously mentioned, the diffusion model 110 may cycle through multiple iterations to arrive at the images 140 that meet the multiple text descriptions.

In one embodiment, the control module 330 includes instructions that, when executed by the processor(s) 310, cause the processor(s) 310 generate the plurality of images 140 based on at least a plurality of numerical constraints 130. As such, the diffusion model 110 may be trained to output multiple images 140 based on multiple numerical constraints 130. As an example, the multiple numerical constraints 130 may include, as an example, a drag coefficient, a manufacturability criterion, and a vehicle dimension. The diffusion model 110 may receive the multiple numerical constraints 130 and then generate images 140 that meet the multiple numerical constraints 130. As previously mentioned, the diffusion model 110 may cycle through multiple iterations to arrive at the images 140 that meet the multiple numerical constraints 130.

In one embodiment, the control module 330 includes instructions that, when executed by the processor(s) 310, cause the processor(s) 310 to train the diffusion model 110 to generate the plurality of images 140 based on at least two inputs. As previously disclosed, the two inputs may be a textual artistic guidance 120 and a numerical constraint 130. In general, the diffusion model 110 may be trained to output and capable of outputting multiple images 140 based on multiple textual artistic guidances 120 and multiple numerical constraints 130.

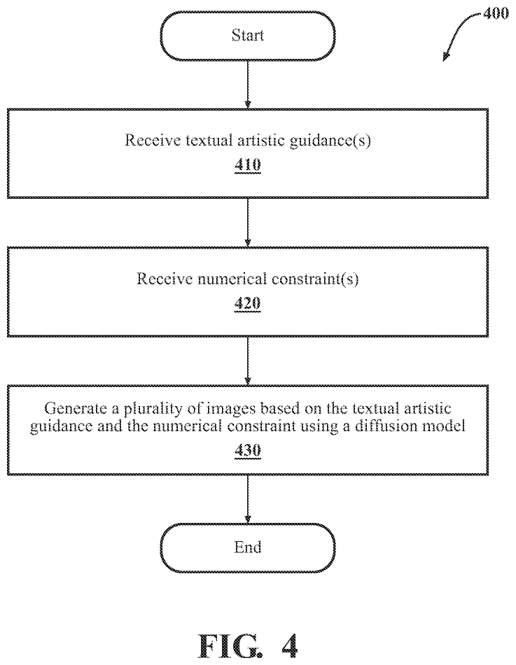

FIG. 4 is a flowchart illustrating one embodiment of a method 400 associated with vehicle design. The method 400 will be described from the viewpoint of the vehicle design system 100 of FIGS. 1-3. However, the method 400 may be adapted to be executed in any one of several different situations and not necessarily by the vehicle design system 100 of FIGS. 1-3.

At step 410, the control module 330 may cause the processor(s) 310 to receive textual artistic guidance(s) 120. The control module 330 may feed the textual artistic guidance(s) 120 to the diffusion model 110.

At step 420, the control module 330 may cause the processor(s) 310 to receive numerical constraint(s) 130. The control module 330 may feed the numerical constraint(s) 130 to the diffusion model 110.

At step 430, the control module 330 may cause the processor(s) 310 to generate a plurality of images 140 based on the textual artistic guidance 120 and the numerical constraint 130 using a diffusion model 110. The diffusion model 110 may use any suitable method to generate the images 140 based on the textual artistic guidance 120 and the numerical constraint 130.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4 but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having.” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory storing machine-readable instructions that, when executed by the processor, cause the processor to:
generate a plurality of images based on a textual artistic guidance and a numerical constraint using a diffusion model.

2. The system of claim 1, wherein the plurality of images are representations of a vehicle.

3. The system of claim 1, wherein the textual artistic guidance is a description of a vehicle.

4. The system of claim 1, wherein the numerical constraint is based on one of:
a drag coefficient;
a manufacturability criterion;
a vehicle dimension;
a vehicle structural strength; or
a vehicle weight distribution.

5. The system of claim 1, wherein the machine-readable instructions further include instructions that when executed by the processor cause the processor to:
train the diffusion model to generate the plurality of images based on at least two inputs.

6. The system of claim 1, wherein the machine-readable instructions further include instructions that when executed by the processor cause the processor to:
generate the plurality of images based on at least a plurality of textual artistic guidance.

7. The system of claim 1, wherein the machine-readable instructions further include instructions that when executed by the processor cause the processor to:
generate the plurality of images based on at least a plurality of numerical constraints.

8. A method comprising:
generating a plurality of images based on a textual artistic guidance and a numerical constraint using a diffusion model.

9. The method of claim 8, wherein the plurality of images are representation of a vehicle.

10. The method of claim 8, wherein the textual artistic guidance is a description of a vehicle.

11. The method of claim 8, wherein the numerical constraint is based on one of:
a drag coefficient;
a manufacturability criterion;
a vehicle dimension;
a vehicle structural strength; or
a vehicle weight distribution.

12. The method of claim 8, further comprising:
training the diffusion model to generate the plurality of images based on at least two inputs.

13. The method of claim 8, further comprising:
generating the plurality of images based on at least a plurality of textual artistic guidance.

14. The method of claim 8, further comprising:
generating the plurality of images based on at least a plurality of numerical constraints.

15. A non-transitory computer-readable medium including instructions that when executed by a processor cause the processor to:
generate a plurality of images based on a textual artistic guidance and a numerical constraint using a diffusion model.

16. The non-transitory computer-readable medium of claim 15, wherein the plurality of images are representations of a vehicle.

17. The non-transitory computer-readable medium of claim 15, wherein the textual artistic guidance is a description of a vehicle.

18. The non-transitory computer-readable medium of claim 15, wherein the numerical constraint is based on one of:
a drag coefficient,
a manufacturability criterion,
a vehicle dimension,
a vehicle structural strength, or
a vehicle weight distribution.

19. The non-transitory computer-readable medium of claim 15, wherein the instructions further include instructions that when executed by the processor cause the processor to:
train the diffusion model to generate the plurality of images based on at least two inputs.

20. The non-transitory computer-readable medium of claim 15, wherein the instructions further include instructions that when executed by the processor cause the processor to:
generate the plurality of images based on at least a plurality of textual artistic guidance.
